(19) United States
(12) Patent Application Publication
(10) Pub. No.: US 2018/0262104 A1
(43) Pub. Date: Sep. 13, 2018

(54) ENERGY MANAGEMENT METHOD AND APPARATUS

(71) Applicants: INDUSTRIAL TECHNOLOGY RESEARCH INSTITUTE, Hsinchu (TW); INTEL CORPORATION, Santa Clara, CA (US)

(72) Inventors: Chao-Jen HUANG, Taichung City (TW); Ching-Ju LIN, Hsinchu City (TW); Su-Hwan KIM, Santa Clara, CA (US)

(21) Appl. No.: 15/454,606

(22) Filed: Mar. 9, 2017

(51) Int. Cl. H02M 3/04; G05B 15/02

(52) U.S. Cl. CPC H02M 3/04; G05B 15/02

(57) ABSTRACT

An energy management apparatus is provided. The energy management apparatus includes an input configured to receive an input voltage from an energy harvester, a first output coupled to device load circuit, a second output coupled to an energy storage device, and a converter circuit. The converter circuit includes an inductor. The converter circuit is coupled between the input, the first output, and the second output. The converter circuit is configured to use the inductor for generating a load current at the first output and generating a charging current at the second output. The converter circuit is configured to operate in a direct feeding mode to generate the load current from the energy harvester in order to provide a regulated output voltage to the device load circuit.

### TECHNICAL FIELD

The disclosure relates in general to energy management method and apparatus applied to an energy harvester.

### BACKGROUND

The development of Internet of Things (IoT), which involves internetworking of physical devices, it is important for a physical device to have a cheap, light, and small volume. As the requirement has become more and more important, there is a need for a single inductor converter apparatus that can be applied to IoT devices.

### SUMMARY

The disclosure is directed to energy management method and apparatus.

According to one embodiment, an energy management apparatus is provided. The energy management apparatus includes an input configured to receive an input voltage from an energy harvester, a first output coupled to a device load circuit, a second output coupled to an energy storage device, and a converter circuit. The converter circuit includes an inductor. The converter circuit is coupled between the input, the first output, and the second output. The converter circuit is configured to use the inductor for generating a load current at the first output and generating a charging current at the second output. The converter circuit is configured to operate in a direct feeding mode to generate the load current from the energy harvester in order to provide a regulated output voltage to the device load circuit.

According to another embodiment, an energy management method is provided. The method includes the following steps. Perform a power conversion operation by a converter circuit according to a duty cycle signal so as to convert an input power supplied by an energy harvester into an output power fed to a device load circuit, and to store a supply voltage on an energy storage device, wherein the converter circuit includes an inductor. Adjust the duty cycle signal to track a maximum power point of the input power or the output power. Generate a load current from the energy harvester in order to provide a regulated output voltage to the device load circuit after the maximum power point of the input power or the output power has been tracked successfully.

### BRIEF DESCRIPTION OF THE DRAWINGS

FIG. 1 shows a diagram illustrating an energy management apparatus according to an embodiment of this disclosure.

FIG. 2 shows a diagram illustrating an example energy flow in the energy management apparatus according to an embodiment of this disclosure.

FIG. 3 shows a diagram illustrating another example energy flow in the energy management apparatus according to an embodiment of this disclosure.

FIG. 4 shows a diagram illustrating an energy management apparatus including a control circuit according to an embodiment of this disclosure.

FIG. 5A shows a diagram illustrating an example of the inductor current in different operation modes according to an embodiment of this disclosure.

FIG. 5B shows a diagram illustrating another example of the inductor current in different operation modes with multiple device load circuits according to an embodiment of this disclosure.

FIG. 6 shows a diagram illustrating another example of the inductor current in different operation modes according to an embodiment of this disclosure.

FIG. 7A shows a diagram illustrating an energy management apparatus operating in the first phase of the direct feeding mode according to an embodiment of this disclosure.

FIG. 7B shows a diagram illustrating an energy management apparatus operating in the second phase of the direct feeding mode according to an embodiment of this disclosure.

FIG. 7C shows a diagram illustrating an energy management apparatus operating in the energy storing mode according to an embodiment of this disclosure.

FIG. 8 shows a flowchart illustrating an energy management method according to an embodiment of this disclosure.

FIG. 9 shows a flowchart illustrating an example of energy management method including MPPT and flag setting according to an embodiment of this disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

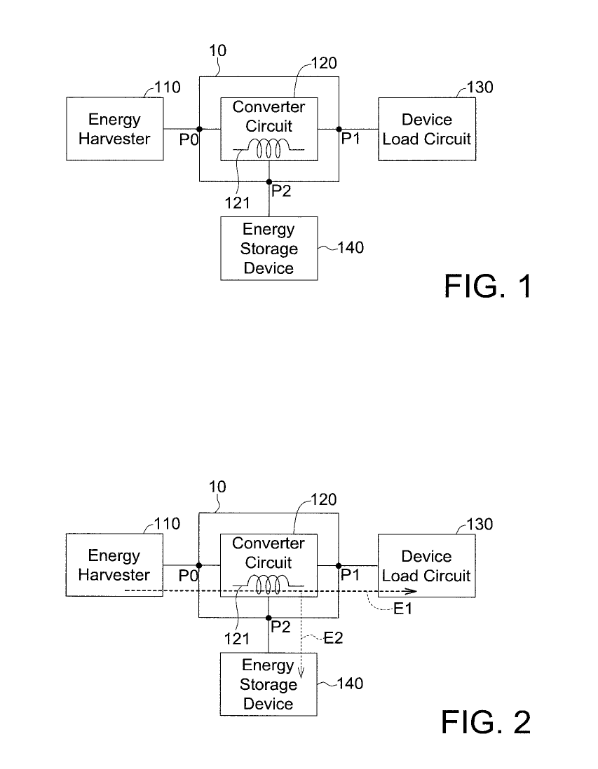

FIG. 1 shows a diagram illustrating an energy management apparatus according to an embodiment of this disclosure. The energy management apparatus 10 includes an input P0 configured to receive an input voltage from an energy harvester 110, a first output P1 coupled to a device load circuit 130, a second output P2 coupled to an energy storage device 140, and a converter circuit 120. The converter circuit 120 includes an inductor 121. The converter circuit 120 is coupled between the input P0, the first output P1, and the second output P2. The converter circuit 120 is configured to use the inductor 121 for generating a load current at the first output P1 and generating a charging current at the second output P2. The converter circuit 120 is configured to operate in a direct feeding mode to generate the load current from the energy harvester 110 in order to provide a regulated output voltage to the device load circuit 130.

The energy harvester 110 may convert mechanical or thermal energy into electrical energy. In one embodiment, the energy harvester 110 may be a photovoltaic cell or a thermoelectric energy source, which belong to direct-current (DC) type of energy harvester. Note that alternating-current (AC) type of energy harvester may also be applicable by incorporating a rectifier. AC type energy harvester may include electro-dynamic, piezoelectric energy harvesters and a radio-frequency antenna.

In one embodiment, the converter circuit 120 may include a DC-DC converter, such as a synchronous DC-DC converter or an asynchronous DC-DC converter. For example, the converter circuit 120 may be a buck converter (step-down converter), a boost converter (step-up converter), a buck-boost converter, a flyback converter, a forward converter, a SEPIC converter (Single-Ended Primary Inductance Converter), or a Ćuk converter. The converter circuit 120 includes the inductor 121 for storing and releasing energy to facilitate energy transfer. The current flowing through the inductor 121 (also referred to as the inductor current I_{L} in the following description) increases or decreases according to the voltage difference across the inductor 121 (v=Ldi/dt for an inductor). Energy is stored in the inductor 121 when the inductor current I_{L} increases, and energy is released from the inductor 121 when the inductor current I_{L} decreases.

Note that one energy harvester is illustrated in FIG. 1. However, there may be more than one energy harvester coupled to the energy management apparatus 10. In this scenario, multiple energy harvesters share the same single inductor 121 for power conversion. In addition, there may also be more than one device load circuit coupled to the energy management apparatus 10. Appropriate control is required for the energy management apparatus 10 to switch between the multiple energy harvesters and the multiple device load circuits.

In one embodiment, the energy storage device 140 may include a battery device, such as a rechargeable battery. In another embodiment, the energy storage device 140 may include a capacitor. The converter circuit 120 uses an inductor 121 to perform a power conversion operation, for transferring energy between the energy harvester 110, the inductor 121, the device load circuit 130, and the energy storage device 140. For example, the energy harvester 110 may provide power to the device load circuit 130 through the inductor 121, the energy storage device 140 may provide power to the device load circuit 130 through the inductor 121, and the energy harvester 110 may provide power to charge the energy storage device 140 through the inductor 121, and so on. Detailed description of these operations is given below.

FIG. 2 shows a diagram illustrating an example energy flow in the energy management apparatus according to an embodiment of this disclosure. The energy flow E1 represents the direct feeding mode in which the load current for the device load circuit 130 is generated from the energy harvester 110. A regulated output voltage is provided to the device load circuit 130. The energy flow E1 does not pass through the energy storage device 140. In other words, the energy harvester 110 provides power directly to the device load circuit 130. As compared to a scenario where the energy harvester 110 first provides power to the energy storage device 140, and then the energy storage device 140 provides power to the device load circuit 130, two energy conversion stages are required in such operation. Because each energy conversion stage may induce a certain amount of energy loss, in the direct feeding mode as described above, only one energy conversion stage is required, and thus the energy conversion efficiency can be enhanced.

The direct feeding mode may be divided into a first phase and a second phase. In the first phase, energy is transferred from the energy harvester 110 to the inductor 121. The current flowing through the inductor 121 increases in the first phase. Energy is thus stored in the inductor 121. After the first phase, energy is then transferred from the inductor 121 to the device load circuit 130. The current flowing through the inductor 121 decreases in the second phase in which energy is released from the inductor 121. The second phase may also be referred to as the regulation phase.

The direct feeding mode is to provide the regulated voltage to the device load circuit 130. In one embodiment, the voltage level at the first output P1 coupled to the device load circuit 130 may be detected. After the voltage level has reached the regulated voltage, there may be still some remaining energy in the inductor 121. In this case, the direct feeding mode may end when the regulated voltage has been successfully provided. Then the converter circuit 120 is configured to operate in an energy storing mode after the direct feeding mode. The energy flow E2 in FIG. 2 represents the energy storing mode in which the remaining energy in the inductor 121 is transferred to the energy storage device 140. For example, by providing a charging current at the second output P2 in order to store a supply voltage on the energy storage device 140.

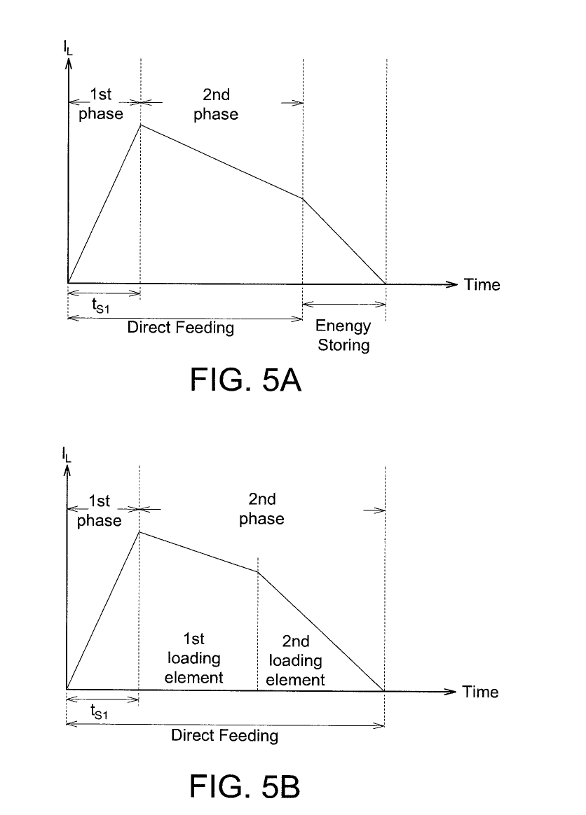

FIG. 5A shows a diagram illustrating an example of the inductor current in different operation modes according to an embodiment of this disclosure. The inductor current I_{L} increases in the first phase of the direct feeding mode, decreases in the second phase of the direct feeding mode, and continues to decrease in the energy storing mode after the second phase of the direct feeding mode. In other words, the remaining energy in the inductor 121 after the direct feeding mode is released in the energy storing mode.

FIG. 5B shows a diagram illustrating another example of the inductor current in different operation modes with multiple device load circuits according to an embodiment of this disclosure. In one embodiment, the device load circuit 130 includes a first loading element and a second loading element. The first loading element and the second loading element may require different regulated voltages. As shown in FIG. 5B, after the first phase of the direct feeding mode, the inductor current I_{L} decreases in the second phase of the direct feeding mode to first provide a regulated output voltage to the first loading element. After the first loading element acquires sufficient energy, power may then be transferred to the second loading element. As shown in FIG. 5B, the inductor current I_{L} continues to decrease (with different slope) in the second phase of the direct feeding mode to provide another regulated output voltage to the second loading element.

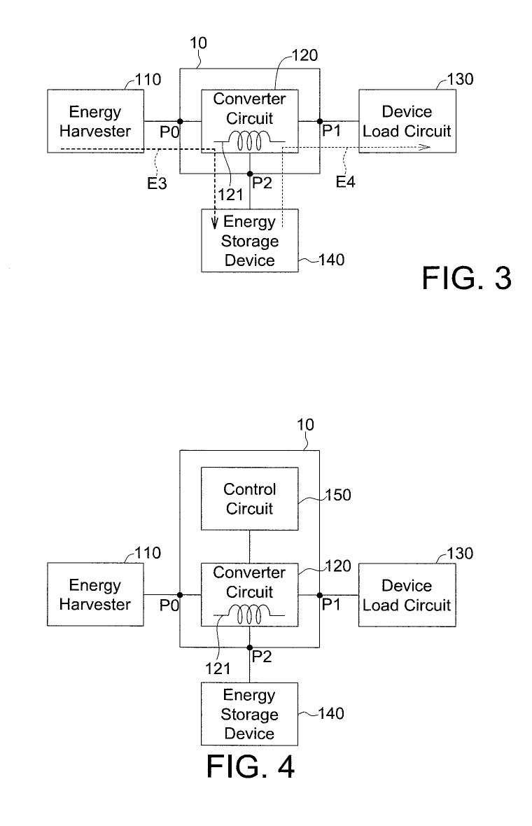

FIG. 3 shows a diagram illustrating another example energy flow in the energy management apparatus according to an embodiment of this disclosure. The energy flow E3 represents a power input mode. The converter circuit 120 is configured to operate in the power input mode to generate the charging current for the energy storage device 140 from the energy harvester 110 in order to store the supply voltage on the energy storage device 140. The energy flow E4 represents a power output mode. The converter 120 is configured to operate in the power output mode to generate the load current for the device load circuit 130 from the supply voltage supplied by the energy storage device 140 in order to provide the regulated output voltage to the device load circuit 130.

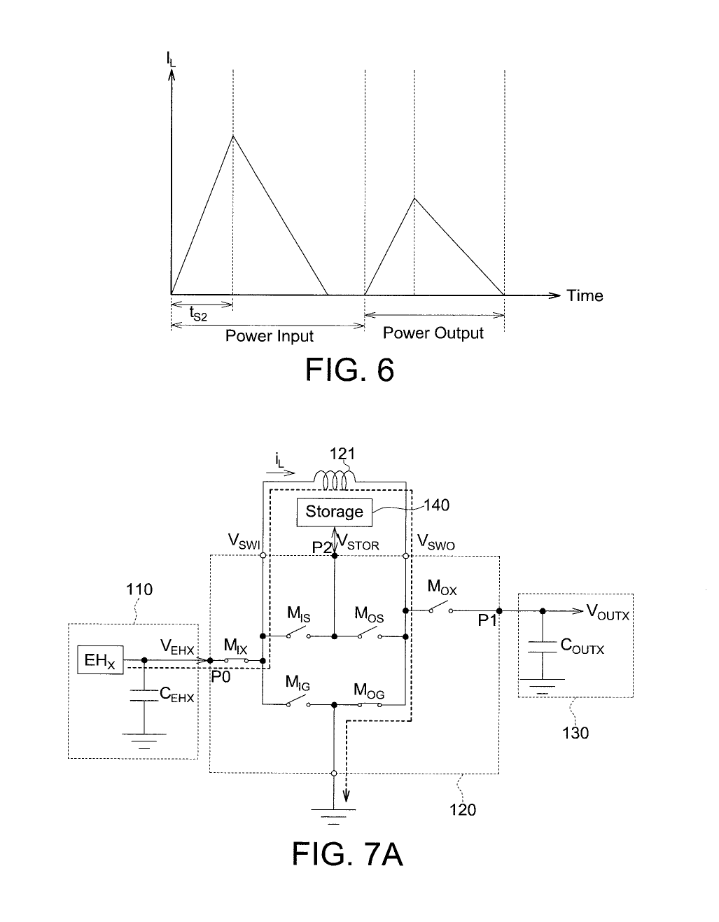

FIG. 6 shows a diagram illustrating another example of the inductor current in different operation modes according to an embodiment of this disclosure. In the power input mode, energy is first transferred from the energy harvester 110 to the inductor 121, and thus the inductor current I_{L} increases. Then energy is transferred from the inductor 121 to the energy storage device 140, and thus the inductor current I_{L} decreases. In the power output mode, energy is first transferred from the energy storage device 140 to the inductor 121, and thus the inductor current I_{L} increases. Then energy is transferred from the inductor 121 to the device load circuit 130, and thus the inductor current I_{L} decreases.

Although the power output mode is illustrated immediately after the power input mode in FIG. 6, the power input mode and the power output mode do not necessarily happen one after another. For example, when the device load circuit 130 does not need power, the converter circuit 120 may be configured to operate in the power input mode for several cycles, such as repeating the power input mode shown in FIG. 6 for several times. On the other hand, when the energy storage device 140 has sufficiently large capacity, the converter circuit 120 may also be configured to operate in the power output mode repeatedly for several cycles.

In one embodiment, the operation mode of the converter circuit 120 (direct feeding mode, energy storing mode, power input mode, power output mode) is controlled by a duty cycle signal. FIG. 4 shows a diagram illustrating an energy management apparatus including a control circuit according to an embodiment of this disclosure. In this embodiment, the energy management apparatus 10 includes a control circuit 150 that generates the duty cycle signal. The duty cycle signal may be a control signal with one or more bits. For example, there may be one or more switches in the converter circuit 120, and each switch in the converter circuit 120 may be controlled by one bit of the duty cycle signal. Note that the connection between the control circuit 150 and the converter circuit 120 may include more than one signal wires. For example, the control circuit 150 may provide the duty cycle signal to the converter circuit 120 to control the power conversion operation, and the control circuit 150 may also receive the operating condition, such as current or voltage, from the converter circuit 120 to generate the duty cycle signal accordingly.

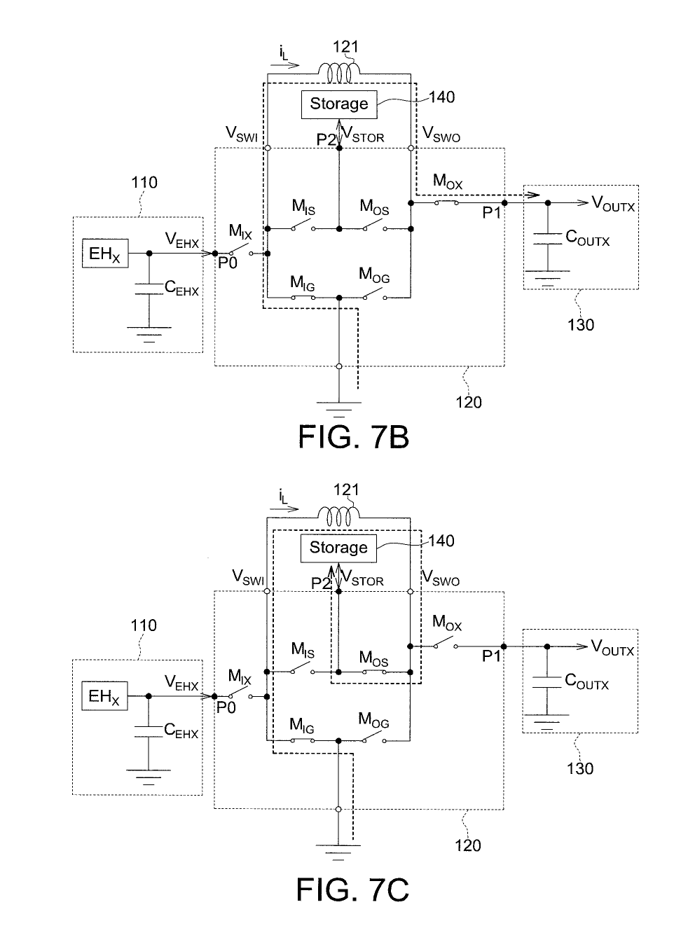

One possible implementation of the converter circuit 120 is given below. FIG. 7A shows a diagram illustrating an energy management apparatus operating in the first phase of the direct feeding mode according to an embodiment of this disclosure. In this embodiment, multiple energy harvesters EH_{X} (X=1, 2, 3, . . . , representing an index of multiple energy harvesters) are coupled to the converter circuit 120 having a single inductor 121. Note that the inductor 121 in FIG. 7A is illustrated outside the converter circuit 120 for clear illustration purpose. Similarly, only one energy harvester EH_{X} and one corresponding switch M_{IX} are shown in the figure also for clear illustration purpose. In addition, there may also be multiple output device load circuits connected to the converter circuit 120. Switches inside the converter circuit 120 are controlled by the duty cycle signal generated by the control circuit 150 as shown in FIG. 4 to control the operation mode.

The converter circuit 120 may include a first switch M_{IX}, a second switch M_{IG}, a third switch M_{OG}, a fourth switch M_{IS}, a fifth switch M_{OS}, and a sixth switch M_{OX}. The first switch M_{IX} is coupled between the input P0 and a first terminal of the inductor 121 (the left end of the inductor 121 in FIG. 7A). The first switch M_{IX} may include several switch elements, with each one corresponding to one energy harvester EH_{X}. The second switch M_{IG} is coupled between the first terminal of the inductor 121 and a reference node. The reference node may be a node with a stable reference voltage level, such as the ground level shown in FIG. 7A. The third switch M_{OG} is coupled between a second terminal of the inductor 121 (the right end of the inductor 121 in FIG. 7A) and the reference node. The fourth switch M_{IS} is coupled between the first terminal of the inductor 121 and the second output P2. The fifth switch M_{OS} is coupled between the second terminal of the inductor 121 and the second output P2. The sixth switch M_{OX} is coupled between the second terminal of the inductor 121 and the first output P1. The sixth switch M_{OX} may also include several switch elements, with each one corresponding to one device load circuit.

As shown in FIG. 7A, the first switch M_{IX} and the third switch M_{OG} are turned on, and the second switch M_{IG}, the fourth switch M_{IS}, the fifth switch M_{OS}, the sixth switch M_{OX} are turned off in the first phase of the direct feeding mode. The current flow is illustrated as a dashed arrow in FIG. 7A. The left end of the inductor 121 has a higher voltage than the right end of the inductor 121, and hence the inductor current I_{L} increases in the first phase of the direct feeding mode.

FIG. 7B shows a diagram illustrating an energy management apparatus operating in the second phase of the direct feeding mode according to an embodiment of this disclosure. The second switch M_{IG} and the sixth switch M_{OX} are turned on, and the first switch M_{IX}, the third switch M_{OG}, the fourth switch M_{IS}, the fifth switch M_{OS} are turned off in the second phase of the direct feeding mode. The current flow is illustrated as a dashed arrow in FIG. 7B. The left end of the inductor 121 has a lower voltage than the right end of the inductor 121 (in this case the first output P1), and hence the inductor current I_{L} decreases in the second phase of the direct feeding mode. Note that in FIG. 7A and FIG. 7B, power is provided from the energy harvester 110 directly to the device load circuit 130 without passing through the energy storage device 140.

FIG. 7C shows a diagram illustrating an energy management apparatus operating in the energy storing mode according to an embodiment of this disclosure. The second switch M_{IG} and the fifth switch M_{OS} are turned on, and the first switch M₁ₓ, the third switch M_{OG}, the fourth switch M_{IS}, the sixth switch M_{OX} are turned off in the energy storing mode. After the direct feeding mode, the remaining energy in the inductor 121 in transferred to the energy storage device 140. The current flow is illustrated as a dashed arrow in FIG. 7C. The left end of the inductor 121 has a lower voltage than the right end of the inductor 121 (in this case the second output P2), and hence the inductor current I_{L} decreases in the energy storing mode.

Referring to the architecture shown in FIG. 4, in one embodiment, the control circuit 150 may be configured to adjust the duty cycle signal so as to track a maximum power point (MPP) of input power supplied by the energy harvester 110 or the output power fed to the device load circuit 130. For example, a perturb and observe approach may be adopted for maximum power point tracking (MPPT). The approach involves perturbing the voltage level of input voltage from the energy harvester 110, and then observing the corresponding input power (which may be detected through various electric characteristics of the converter circuit 120, such as voltage or current) to find out the MPP. It may require some time for the control circuit 150 to successfully track the MPP of the input power or the output power.

In one embodiment, before the MPP has been tracked successfully, the converter circuit 120 is configured to operate in the power input mode and/or the power output mode (referred in FIG. 3 and FIG. 6). For example, the control circuit 150 may adjust the duty cycle signal in an attempt to find the MPP during the power input mode. After the MPP has been tracked successfully, the converter circuit 120 is configured to operate in the direct feeding mode. Because the optimum operating condition of the energy harvester 110 has been identified after the MPP has been tracked successfully, the energy harvester 110 is then able to provide power directly to the device load circuit 130 to enhance energy conversion efficiency.

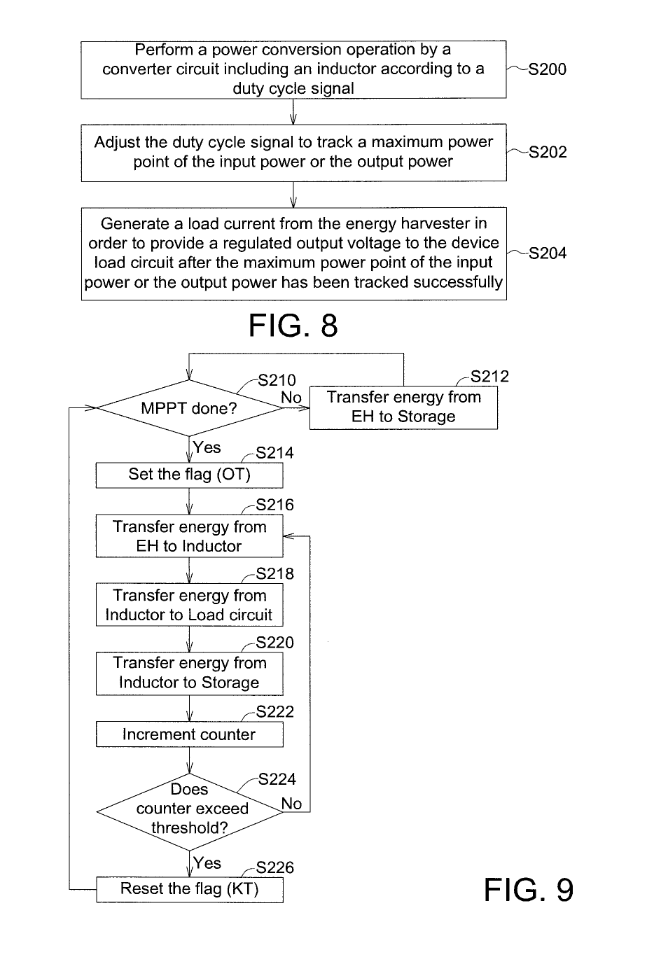

FIG. 8 shows a flowchart illustrating an energy management method according to an embodiment of this disclosure. The method includes the following steps. Step S200: Perform a power conversion operation by a converter circuit according to a duty cycle signal so as to convert an input power supplied by an energy harvester into an output power fed to a device load circuit, and to store a supply voltage on an energy storage device, wherein the converter circuit includes an inductor. The corresponding block diagram may be referred to FIG. 1.

Step S202: Adjust the duty cycle signal to track a maximum power point of the input power or the output power. The duty cycle signal may be generated by a control circuit (such as the control circuit 150 shown in FIG. 4). In one embodiment, step S202 is performed by adjusting the duty cycle of the duty cycle signal. For example, a pulse width modulation scheme may be adopted by the control circuit 150. The duty cycle of the duty cycle signal controls the time length t_{S2} shown in FIG. 6, resulting in different input power supplied by the energy harvester 110.

Step S204: Generate a load current from the energy harvester in order to provide a regulated output voltage to the device load circuit after the maximum power point of the input power or the output power has been tracked successfully. Once the MPP has been found, the converter circuit 120 may operate in the direct feeding mode. In this case the duty cycle of the duty cycle signal controls the time length t_{S1} shown in FIG. 5A. After the step S204, if there is still remaining energy in the inductor 121, a charging current may be generated from the inductor 121 in order to store the supply voltage on the energy storage device 140 (the energy storing mode referred in FIG. 2 and FIG. 5A).

In one embodiment, the energy management method includes a step of generating a charging current from the energy harvester in order to store the supply voltage on the energy storage device (the power input mode referred in FIG. 3 and FIG. 6) when the maximum power point of the input power or the output power has not been tracked successfully.

In one embodiment, the energy management method includes a step of generating the load current from the supply voltage in order to provide the regulated output voltage to the device load circuit (the power output mode referred in FIG. 3 and FIG. 6). This step may be performed irrespective of whether the maximum power point of the input power or the output power has been tracked successfully or not.

In one embodiment, a flag value may be set or reset according to the result of the maximum power point tracking. The flag value may be present in the converter circuit 120 for example. The flag value may be either set to OT (representing on track) or reset to KT (representing keep tracking). Initially and during the maximum power point tracking procedure, the flag value is set to KT. The flag value is set to OT when the maximum power point of the input power or the output power has been tracked successfully. Therefore when the flag value is OT, the converter circuit 120 is configured to operate in the direct feeding mode.

In one embodiment, this flag value may be reset periodically or after a time period has passed since the flag value is set. For example, a time duration after the flag value has been set may be obtained. When the time duration exceeds a threshold value, the flag value is reset to KT. The time duration may be obtained by the control circuit 150. For example, the control circuit 150 may include a counter circuit. The counter circuit may start counting once the flag is set to OT. When the counting value of the counter circuit exceeds the threshold value, the flag is then reset to KT.

FIG. 9 shows a flowchart illustrating an example of energy management method including MPPT and flag setting according to an embodiment of this disclosure. Step S210: check whether or not MPPT is done (whether or not the MPP has been tracked successfully). If not, proceed to step S212, continue to perform MPPT, and transfer energy from the energy harvester 110 to the energy storage device 140. If yes, proceed to step S214: set the flag value to OT. The converter circuit 120 is configured to operate in the direct feeding mode. Step S216: transfer energy from the energy harvester 110 to the inductor 121 (the first phase of the direct feeding mode). Step S218: transfer energy from the inductor 121 to the device load circuit 130 (the second phase of the direct feeding mode). Step S220: transfer energy from the inductor 121 to the energy storage device 140 (the energy storing mode). The step S220 is sometimes skipped because there may be no remaining energy in the inductor 121 after the step S218. Step S222: increment counter to calculate the time duration after the flag has been set. Step S224: check whether the counter exceed the threshold value. If not, go back to step S216 and repeat the steps S216-S222. If yes, proceed to step S226: reset the flag value to KT. Because the flag value is now KT, perform MPPT again and go back to step S210 to repeat the above described procedure.

According to the energy management method and apparatus disclosed herein, because the energy harvester is able to provide power directly to the device load circuit without passing through the energy storage device, the energy conversion efficiency can be improved. In addition, MPPT can be performed in the converter circuit. After the MPPT procedure is complete, the converter circuit is configured to operate in the direct feeding mode. Because after MPPT the energy harvester is able to provide the maximum power, making the energy harvester a more reliable and efficient power supply for the device load circuit.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An energy management apparatus, comprising:
an input configured to receive an input voltage from an energy harvester;
a first output coupled to a device load circuit;
a second output coupled to an energy storage device; and
a converter circuit, comprising an inductor, the converter circuit coupled between the input, the first output, and the second output, the converter circuit configured to use the inductor for generating a load current at the first output and generating a charging current at the second output;
wherein the converter circuit is configured to operate in a direct feeding mode to generate the load current from the energy harvester in order to provide a regulated output voltage to the device load circuit.

2. The energy management apparatus according to claim 1, wherein the converter circuit is configured to operate in an energy storing mode to generate the charging current from the inductor in order to store a supply voltage on the energy storage device after the direct feeding mode.

3. The energy management apparatus according to claim 2, wherein the energy management apparatus further comprises a control circuit, configured to generate a duty cycle signal for controlling the converter circuit to operate in either the direct feeding mode or the energy storing mode.

4. The energy management apparatus according to claim 3, wherein the control circuit is configured to adjust the duty cycle signal to track a maximum power point of the energy harvester.

5. The energy management apparatus according to claim 4, wherein the converter circuit is configured to operate in the direct feeding mode after the control circuit has successfully tracked the maximum power point of the energy harvester.

6. The energy management apparatus according to claim 3, wherein the direct feeding mode is divided into a first phase and a second phase according to the duty cycle signal, and a current flowing through the inductor increases in the first phase, decreases in the second phase, and continues to decrease in the energy storing mode after the second phase.

7. The energy management apparatus according to claim 6, wherein the converter circuit comprises:
a first switch coupled between the input and a first terminal of the inductor;
a second switch coupled between the first terminal of the inductor and a reference node;
a third switch coupled between a second terminal of the inductor and the reference node;
a fourth switch coupled between the first terminal of the inductor and the second output;
a fifth switch coupled between the second terminal of the inductor and the second output; and
a sixth switch coupled between the second terminal of the inductor and the first output.

8. The energy management apparatus according to claim 7, wherein the first switch and the third switch are turned on, and the second switch, the fourth switch, the fifth switch, the sixth switch are turned off in the first phase of the direct feeding mode.

9. The energy management apparatus according to claim 7, wherein the second switch and the sixth switch are turned on, and the first switch, the third switch, the fourth switch, the fifth switch are turned off in the second phase of the direct feeding mode.

10. The energy management apparatus according to claim 7, wherein the second switch and the fifth switch are turned on, and the first switch, the third switch, the fourth switch, the sixth switch are turned off in the energy storing mode.

11. The energy management apparatus according to claim 1, wherein the converter circuit is configured to operate in a power input mode to generate the charging current from the energy harvester in order to store a supply voltage on the energy storage device.

12. The energy management apparatus according to claim 1, wherein the converter circuit is configured to operate in a power output mode to generate the load current from the supply voltage in order to provide the regulated output voltage to the device load circuit.

13. An energy management method, comprising:
performing a power conversion operation by a converter circuit according to a duty cycle signal so as to convert an input power supplied by an energy harvester into an output power fed to a device load circuit, and to store a supply voltage on an energy storage device, wherein the converter circuit comprises an inductor;
adjusting the duty cycle signal to track a maximum power point of the input power or the output power; and
generating a load current from the energy harvester in order to provide a regulated output voltage to the device load circuit after the maximum power point of the input power or the output power has been tracked successfully.

14. The energy management method according to claim 13, further comprising generating a charging current from the inductor in order to store the supply voltage on the energy storage device after the step of generating the load current from the energy harvester in order to provide the regulated output voltage to the device load circuit.

15. The energy management method according to claim 13, further comprising generating a charging current from the energy harvester in order to store the supply voltage on the energy storage device when the maximum power point of the input power or the output power has not been tracked successfully.

16. The energy management method according to claim 13, further comprising generating the load current from the supply voltage in order to provide the regulated output voltage to the device load circuit.

17. The energy management method according to claim 13, wherein the step of generating the load current from the energy harvester in order to provide the regulated output voltage to the device load circuit comprises:
transferring energy from the energy harvester to the inductor in a first phase, wherein a current flowing through the inductor increases in the first phase; and
transferring energy from the inductor to the device load circuit in a second phase, wherein the current flowing through the inductor decreases in the second phase.

18. The energy management method according to claim 17, further comprising:
transferring energy from the inductor to the energy storage device after the step of transferring energy from the inductor to the device load circuit, wherein the current flowing through the inductor continues to decrease after the second phase.

19. The energy management method according to claim 13, further comprising:
setting a flag value when the maximum power point of the input power or the output power has been tracked successfully;
obtaining a time duration after the flag value has been set; and
resetting the flag value when the time duration exceeds a threshold value.

20. The energy management method according to claim 13, wherein the step of adjusting the duty cycle signal comprises adjusting a duty cycle of the duty cycle signal.
